(19) United States
(12) Patent Application Publication
(10) Pub. No.: US 2025/0389538 A1
(43) Pub. Date: Dec. 25, 2025

(54) TOPOLOGY MAP-BASED ROUTE GUIDING APPARATUS AND METHOD

(71) Applicants: HYUNDAI MOTOR COMPANY, Seoul (KR); KIA CORPORATION, Seoul (KR)

(72) Inventors: Kyungzun Rim, Hwaseong-si (KR); Hotaek Han, Hwaseong-si (KR)

(73) Assignees: HYUNDAI MOTOR COMPANY, Seoul (KR); KIA CORPORATION, Seoul (KR)

(21) Appl. No.: 18/926,080

(22) Filed: Oct. 24, 2024

(30) Foreign Application Priority Data
Jun. 19, 2024 (KR) 10-2024-0079640

(51) Int. Cl. G01C 21/20

(52) U.S. Cl. CPC G01C 21/206

(57) ABSTRACT

A topology map-based route guiding apparatus may include a topology map generated from a guide map image based on an optical character recognition (OCR) character recognition and an image processing; a destination determiner configured to determine, as a destination, a location selected by a user in the topology map; an origin determiner configured to determine, as an origin, a current location of the user detected by comparing a character recognized from a surrounding image provided by the user and location information of the topology map; and a route generator configured to generate a final route from the origin to the destination based on a congestion degree and a preference.

### CROSS-REFERENCE TO RELATED APPLICATION

This application claims priority to and the benefit of Korean Patent Application No. 10-2024-0079640 filed in the Korean Intellectual Property Office on Jun. 19, 2024, the entire contents of which are incorporated herein by reference.

### TECHNICAL FIELD

The present disclosure relates to a topology map-based route guiding apparatus and a topology map-based route guiding method. More particularly, the present disclosure relates to a topology map-based route guiding apparatus and a topology map-based route guiding method that guide users to an optimal route on the topology map.

### BACKGROUND

Conventional route finding technology may provide the fastest route to a user or a robot. However, in some cases, simply providing a fast route is not important for the user.

Conventional route finding technology cannot control the density of people in each space in consideration of user safety, event intention, etc. For example, conventional route finding technology cannot control the crowding of people as much as possible in meaningful spaces at events or exhibitions. Conventional route finding technology cannot provide directions to help people avoid crowded places in consideration of safety if too many people are crowded in one space. The subject matter described in this background section is intended to promote an understanding of the background of the disclosure and thus may include subject matter that is not already known to those of ordinary skill in the art.

### SUMMARY

The present disclosure aims to provide a topology map-based route guiding apparatus and a topology map-based route guiding method capable of guiding a route tailored to the situation in consideration of the congestion degree of the passage and the route preference of a manager by using a topology map to which various information pieces may be added.

A topology map-based route guiding apparatus may include a topology map generated from a guide map image based on an optical character recognition (OCR) character recognition and an image processing. The apparatus may also include a destination determiner configured to determine, as a destination, a location selected by a user in the topology map. The apparatus may also include an origin determiner configured to determine, as an origin, a current location of the user detected by comparing a character recognized from a surrounding image provided by the user and location information of the topology map. The apparatus may also include a route generator configured to generate a final route from the origin to the destination based on a congestion degree and a preference.

The topology map may include a plurality of vertices disposed in a travel passage on the map and respectively storing the location information. The topology map may include edges connecting the vertices.

The origin determiner may be configured to estimate, as the current location of the user, a specific vertex on the topology map having location information matching the recognized character in the surrounding image.

The route generator may be configured to, when a route passing through the origin and the destination is detected from among pre-stored routes, use a detected route as the final route and stop route generation.

The route generator may calculate the congestion degree based on the number of persons in real time obtained through a closed-circuit television (CCTV) of the travel passage and a passage area. The congestion degree is calculated for each edge.

The route generator may be configured to calculate the congestion degree for each edge through Equation 1,

$$edge conjestion degree = 1 + \frac{number of persons detected by CCTV}{optimal number of persons for passage} \qquad [ Equation 1 ]$$

An optimal number of persons for passage is a number predetermined based on passage area.

The preference may be considered to be higher when a preference value preset by the manager is lower, and the preference may be set for each edge.

The route generator may be configured to generate, as the final route, a route comprising a plurality of edges having a low congestion degree and a high preference.

The route generator may be configured to determine, as the final route, a route of a shortest distance between the origin and the destination. When a plurality of candidate routes having the same distance between the origin and the destination exists, the candidate route having a low congestion degree and a high preference among the plurality of candidate routes is determined as the final route.

The route generator may be configured to determine cost for each candidate route through Equation 2 and determine a candidate route having a lowest cost as the final route,

$$cost ( edge id ) = distance ( vertex 1 , vertex 2 ) \times edge congestion degree \times manager factor \qquad [ Equation 2 ]$$

vertex1 is a first side vertex of the edge determining the route, vertex 2 is a second side vertex of the edge, distance (vertex1, vertex2) is a distance between the first side vertex and the second side vertex, an edge congestion degree is the congestion degree for each edge, and a manager factor is a route preference value of a manager for each edge.

A topology map-based route guiding method may include providing a topology map generated from a guide map image based on an OCR character recognition and an image processing. The method may also include determining, as a destination, a location selected by a user in the topology map. The method may also include determining, as an origin, a current location of the user detected by comparing a character recognized from a surrounding image provided by the user and location information of the topology map. The method may also include generating a final route from the origin to the destination based on a congestion degree and a preference.

The topology map may include a plurality of vertices disposed in a travel passage on the map and respectively storing the location information. The topology map may include edges connecting the vertices.

Determining the origin may include estimating, as the current location of the user, a specific vertex on the topology map having location information matching the recognized character in the surrounding image.

Generating the final route may include, when a route passing through the origin and the destination is detected from among pre-stored routes, using a detected route as the final route and stopping stop route generation.

Generating the final route may include calculating the congestion degree based on the number of persons in real time obtained through a CCTV of the travel passage and a passage area. Generating the final route may include calculating the congestion degree for each edge.

Generating the final route further may include calculating the congestion degree for each edge through Equation 1,

$$edge conjestion degree = 1 + \frac{number of persons detected by CCTV}{optimal number of persons for passage} \qquad [ Equation 1 ]$$

An optimal number of persons for passage is a number predetermined based on passage area.

The preference may be considered to be higher when a preference value preset by the manager is lower, and the preference may be set for each edge.

Generating the final route further may include generating, as the final route, a route comprising a plurality of edges having a low congestion degree and a high preference.

Generating the final route may include determining, as the final route, a route of a shortest distance between the origin and the destination. When a plurality of candidate routes having the same distance between the origin and the destination exists, the candidate route having a low congestion degree and a high preference among the plurality of candidate routes is determined as the final route.

Generating the final route further may include determining a cost for each candidate route through Equation 2 and determining a candidate route having a lowest cost as the final route,

$$cost ( edge id ) = distance ( vertex 1 , vertex 2 ) \times edge congestion degree \times manager factor \qquad [ Equation 2 ]$$

vertex1 is a first side vertex of the edge determining the route, vertex 2 is a second side vertex of the edge, distance (vertex1, vertex2) is a distance between the first side vertex and the second side vertex, an edge congestion degree is the congestion degree for each edge, and a manager factor is a route preference value of a manager for each edge.

A topology map-based route guiding apparatus and a topology map-based route guiding method according to an embodiment may guide a route tailored to the situation in consideration of the congestion degree of the passage and the route preference of the manager by using the topology map to which various information pieces may be added.

### BRIEF DESCRIPTION OF THE DRAWINGS

FIG. 1 schematically shows a topology map system according to an embodiment of the present disclosure.

FIG. 2 is a block diagram of a topology map-based route guiding apparatus according to an embodiment of the present disclosure.

FIG. 3 is a flowchart of a topology map-based route guiding method according to an embodiment of the present disclosure.

FIG. 4 is a drawing for explaining a topology map-based route guiding method according to an embodiment of FIG. 3.

FIG. 5 is a flowchart of a topology map-based route guiding method according to an embodiment of the present disclosure.

FIG. 6 and FIG. 7 are example diagrams for explaining a topology map-based route guiding method according to an embodiment of the present disclosure.

FIG. 8 is drawing for explaining a computing device according to an embodiment of the present disclosure.

### DETAILED DESCRIPTION

Embodiments of the present disclosure are described more fully hereinafter with reference to the accompanying drawings such that a person having ordinary skill in the art may easily implement the embodiments. As those having ordinary skill in the art should realize, the described embodiments may be modified in various different ways, without departing from the spirit or scope of the present disclosure. In order to clarify the present disclosure, parts that are not related to the description have been omitted, and the same and equivalent elements are denoted by the same reference numerals throughout the present disclosure.

In addition, unless explicitly described to the contrary, the word “comprise” and variations such as “comprises” or “comprising” should be understood to imply the inclusion of stated elements without excluding any other elements. Terms including an ordinary number, such as first and second, are used for describing various constituent elements, but the constituent elements are not limited by the terms. The terms are only used to differentiate one component from other components.

In addition, the terms, such as “unit”, “part” or “portion”, “-er”, and “module” in the present disclosure, refer to a unit that processes at least one function or operation, which may be implemented by hardware, software, or a combination of hardware and software. When a controller, module, component, device, element, unit, part, portion, “-er,” or the like of the present disclosure is described as having a purpose or performing an operation, function, or the like, the controller, module, component, device, element, unit, part, portion, “-er,” or the like should be considered herein as being “configured to” meet that purpose or to perform that operation or function. Each controller, module, component, device, element, unit, part, portion, “-er,” and the like may separately embody or be included with a processor and a memory, such as a non-transitory computer readable media, as part of the apparatus.

Hereinafter, embodiments of the present disclosure will be described with reference to the drawings.

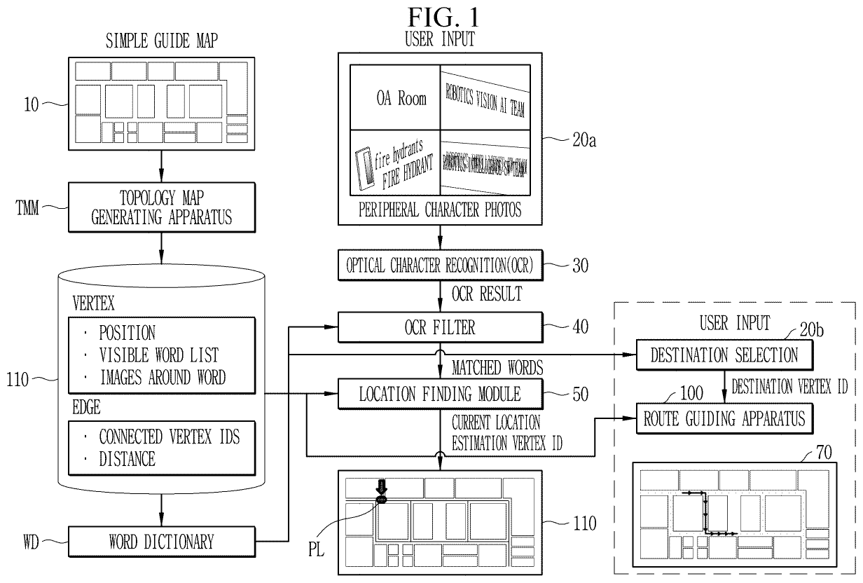

FIG. 1 schematically shows a topology map system according to an embodiment of the present disclosure.

A topology map system may generate a topology map 110 through a topology map generating apparatus TMM.

When the user provides surrounding character photos or a user's surrounding image 20a into the user input through an application or the like, the topology map system may recognize characters through an optical character recognition (OCR) module 30, may find matched characters through an OCR filter 40, and may, based on these, estimate a current location PL of the user on the topology map 110 through a location finding module 50.

When the user inputs a destination selection 20b, the topology map system may provide a topology map-based route guide map 70 through a route guiding apparatus 100 based on the estimated current location PL of the user.

In FIG. 1, the topology map generating apparatus TMM may generate the topology map 110 from a simple guide map image 10.

The topology map generating apparatus TMM may create a topology map TM enabling location finding and route services finding by using the simple guide map.

The topology map generating apparatus TMM may operate offline and on a server. The greatest difference from the existing precise map creation lies in that a map enabling the location estimation and route finding services for people may be created without collecting the sensor data at the service site.

The topology map generating apparatus TMM may be configured to perform a process of creating a vertex and an edge and perform a process of inputting location information. The topology map generating apparatus TMM includes an automatic mode and a manual mode in each of the two above processes.

In the automatic mode, the topology map generating apparatus TMM may recognize the characters from a guide map 10 by using the OCR module 30, may extract a polygon by using the image processing technology to automatically create the vertex and the edge, and may store location information in the created topology map 110 by using the recognition result of the OCR module 30.

In the manual mode, the topology map generating apparatus TMM may provide an interface for generating and/or modifying the topology map 110 to the user.

The topology map generating apparatus TMM may store the location information in the vertex of the topology map 110. For example, the topology map generating apparatus TMM may store location information, word lists, image around words, or the like, of the location, in the vertex of the topology map 110.

The topology map generating apparatus TMM may store a distance between vertices, information of the connected vertices, or the like, in the edge of the topology map 110.

In an embodiment, the topology map 110 may store the location information in a word dictionary WD. The word dictionary WD may store a word matching the location information stored in the vertex in Korean and English.

In FIG. 1, a topology map-based route guiding apparatus 100 may provide a route guiding method tailored to a congestion degree and a preference by utilizing the merits that various information pieces may be added in the topology map 110 and changes may be rapidly applied.

In other words, the topology map-based route guiding apparatus 100 may find a shortest route to the destination selected by the user in the word dictionary WD of the topology map 110 taking, as an origin, a current location of the user determined through the location finding module 50.

During the process of finding the shortest route, the topology map-based route guiding apparatus 100 may reflect the congestion degree of the road on which the user moves and a route preference of a manager.

The topology map-based route guiding apparatus 100 may provide the route-finding or route-guiding service, with various intentions by utilizing the merit of the topology map.

By reflecting the number of persons and passage area information obtained from a closed-circuit television (CCTV) of a travel passage to the topology map 110, the topology map-based route guiding apparatus 100 may guide the route such that persons are not crowded in one place (reflecting the congestion degree).

When there is a space where event organizers or exhibition artists wish to gather people, the topology map-based route guiding apparatus 100 may guide persons to pass through the space, through route guiding (the preference reflecting).

When the user has inputted many destinations desired to go, the topology map-based route guiding apparatus 100 may provide the route guiding service such that the user can visit all destinations most efficiently.

By utilizing expandability of the space, which is another strong point of the topology map 110, the topology map-based route guiding apparatus 100 may provide the route finding service with a small cost in a wide space.

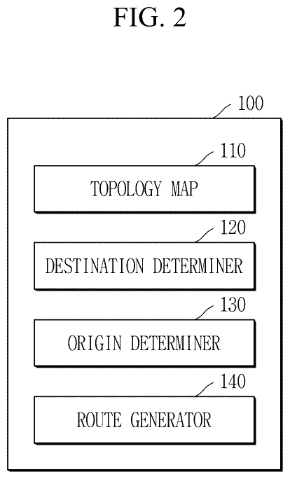

FIG. 2 is a block diagram of a topology map-based route guiding apparatus according to an embodiment of the present disclosure.

Referring to FIG. 2, the topology map-based route guiding apparatus 100 may include the topology map 110, a destination determiner 120, an origin determiner 130, and a route generator 140.

The topology map 110 may be generated based on an OCR character recognition and the image processing, through the topology map generating apparatus TMM (see FIG. 1) based on the guide map image 10 (see FIG. 1). The topology map 110 may include a vertex storing the location information and may include an edge connecting the vertices. The vertex may be estimated by the location of the user, and the edge may configure a route along which the user moves.

The destination determiner 120 may determine a location selected by a user in the topology map 110 as the destination. In other words, when the user inputs the location information of the destination on the topology map 110, the destination determiner 120 may determine it as the destination.

The origin determiner 130 may determine, as the origin, the current location PL (see FIG. 1) of the user detected by comparing the character recognized from the user's surrounding image 20a (see FIG. 1) provided by a user and the location information stored in the topology map.

The location information may be stored for respective vertices of the topology map. The location information may be stored in the word dictionary WD of the topology map. The location information may include a word matching the location, and Korean and English characters may configure the word.

The origin determiner 130 may estimate, as the current location of the user, a specific vertex on the topology map having the location information matching the recognized character in the user's surrounding image.

The origin determiner 130 may filter out the character recognized by the OCR module 30 (see FIG. 1) through the OCR filter 40 (see FIG. 1) to determine a final character. The origin determiner 130 may identify, as the current location of the user, a vertex having the location information on the topology map 110 matching the final character and may determine the current location of the user as the origin.

The route generator 140 may generate a final route from the origin to destination in consideration of the congestion degree and the preference.

When a route passing through the origin and the destination is detected from among pre-stored routes, the route generator 140 may use the detected route as the final route and may stop route generation.

The route generator 140 may calculate the congestion degree based on the number of persons in real time obtained through the CCTV of the user travel passage and a passage area. The congestion degree may be calculated for each edge.

The route generator 140 may calculate the congestion degree for each edge through Equation 1.

$$edge conjestion degree = 1 + \frac{number of persons detected by CCTV}{optimal number of persons for passage} \qquad [ Equation 1 ]$$

Here, the optimal number of persons for passage is a number predetermined based on the passage area.

The preference is considered to be higher when the preference value preset by the manager is lower. The preference may be set for each edge.

The route generator 140 may generate, as the final route, a route comprising a plurality of edges having the low congestion degree is low and the high preference.

The route generator 140 may determine, as the final route, a route of a shortest distance between the origin and the destination.

When a plurality of candidate routes having the same distance between the origin and the destination exists, the route generator 140 may determine, as the final route, the candidate route having the low congestion degree and the high preference among the plurality of candidate routes.

The route generator 140 may determine cost for each candidate route through Equation 2 and may determine, as the final route, the candidate route having a lowest cost.

$$cost ( edge id ) = distance ( vertex 1 , vertex 2 ) \times edge congestion degree \times manager factor \qquad [ Equation 2 ]$$

Here, vertex1 is a first side vertex of the edge determining the route, vertex 2 is a second side vertex of the edge, distance (vertex1, vertex2) is a distance between the first side vertex and the second side vertex, the edge congestion degree is the congestion degree for each edge, and manager factor is the route preference value of the manager for each edge.

One of the first side vertex or the second side vertex of the edge determining the route may be the origin, and the other may be the destination.

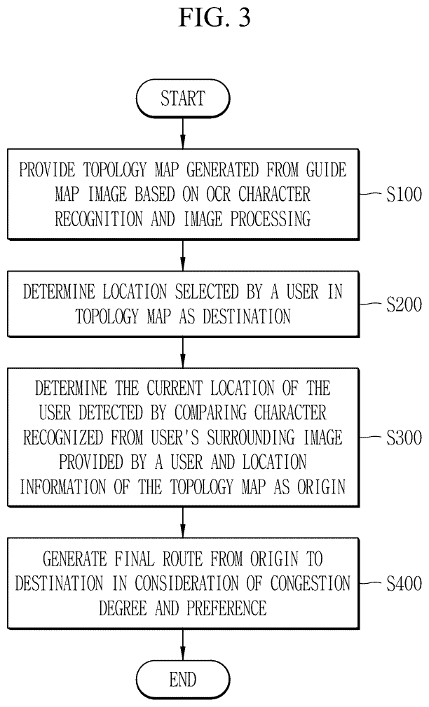

FIG. 3 is a flowchart of a topology map-based route guiding method according to an embodiment of the present disclosure. The topology map-based route guiding method may be performed through the topology map-based route guiding apparatus 100 (see FIG. 1).

In FIG. 3, at step S100, the topology map-based route guiding apparatus 100 may provide the topology map generated from the guide map image based on the OCR character recognition and the image processing.

The topology map may include a plurality of vertices disposed in the user's travel passage and respectively storing the location information. The topology map may include edges connecting the vertices.

At step S200, the topology map-based route guiding apparatus 100 may determine, as the destination, the location selected by a user in the topology map.

At step S300, the topology map-based route guiding apparatus 100 may determine, as the origin, the current the location of the user detected by comparing a character recognized from the user's surrounding image provided by a user and the location information of the topology map.

The topology map-based route guiding apparatus 100 may estimate, as the current location of the user, the specific vertex on the topology map having the location information matching the recognized character in the user's surrounding image.

At step S400, the topology map-based route guiding apparatus 100 may generate the final route from the origin to the destination in consideration of the congestion degree and the preference.

When there is a route passing through the origin and the destination among the pre-stored routes, the topology map-based route guiding apparatus 100 may use a corresponding route as the final route and may stop route generation.

The topology map-based route guiding apparatus 100 may determine, as the final route, the route of the shortest distance between the origin and the destination. When the plurality of candidate routes having the same distance between the origin and the destination exists, the topology map-based route guiding apparatus 100 may determine, as the final route, the candidate route having the low congestion degree and the high preference among the plurality of candidate routes.

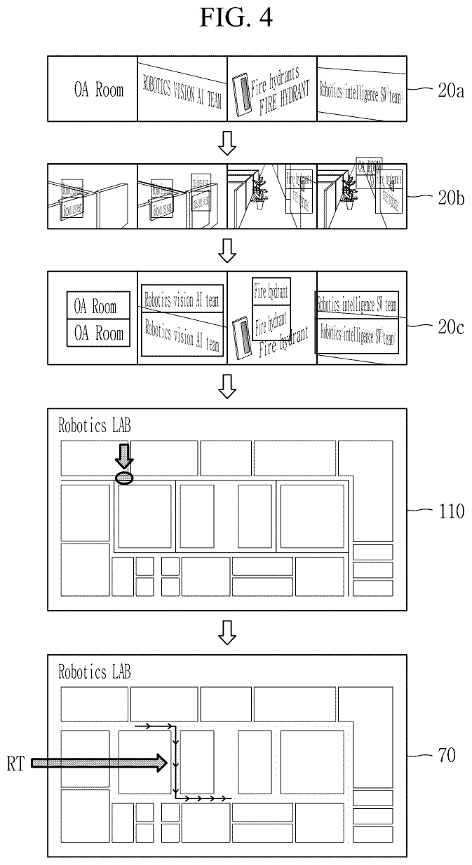

FIG. 4 is a drawing for explaining a topology map-based route guiding method according to an embodiment of FIG. 3.

In FIG. 4, according to the topology map-based route guiding method, the user's surrounding image 20a may be provided as a user input 20a. The user may photograph and upload a sign board, sign, or the like, around the user, to provide the user surrounding character photo as the user input 20a.

Thereafter, an OCR result image 20b may be generated through character recognition and character position detection using the OCR module 30 (see FIG. 1) from the user input 20a. The OCR result image 20b may recognize all characters and character positions included in the user surrounding photo.

Thereafter, through the OCR filter 40 (see FIG. 1), only necessary characters may be extracted from the OCR result image 20b, and other characters are filtered out, to generate the OCR filter result image 20c. The OCR filter result image 20c may only include the final characters matching the characters stored in the topology map (or word dictionary of the topology map) excluding unnecessary characters from the OCR result image 20b.

Thereafter, through the location finding module 50 (see FIG. 1), the user current location PL may be calculated on the topology map 110 from the OCR filter result image 20c. The current location PL may be determined as the origin of the user.

The finally detected user current location PL may be detected as the specific vertex on the topology map storing the location information matching the character of the OCR result image 20b.

In addition, according to the topology map-based route guiding method, the topology map-based route guide map 70 from the origin to the destination may be provided.

The topology map-based route guide map 70 may provide the user with the final route RT on the topology map by reflecting the congestion degree of the passage according to crowding of persons and preferred roads of the manager.

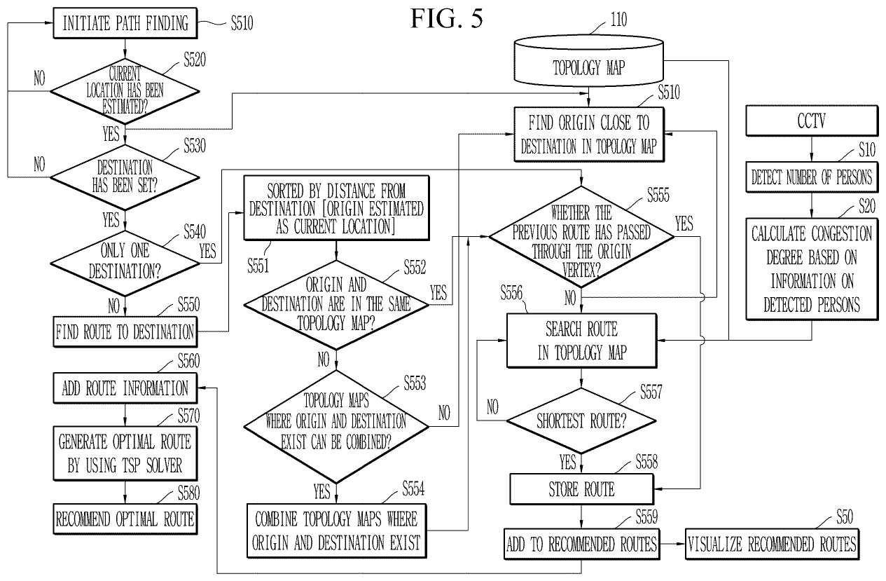

FIG. 5 is a flowchart of a topology map-based route guiding method according to an embodiment of the present disclosure.

The topology map-based route guiding apparatus 100 may find the shortest route to the destination selected by the user in the topology map taking the current location estimated as an origin by the location finding module.

When the route guiding is initiated according to the user request at step S510, the topology map-based route guiding apparatus 100 may determine whether the user's current location has been estimated and whether the destination has been determined at steps S520 and S530.

In other words, the topology map-based route guiding apparatus 100 may operate when the current location and the destination are determined.

In the topology map-based route guiding apparatus 100, because the origin is determined based on OCR location finding, and because the destination is determined based on the topology map, the cases in which there are many origins and many destinations may occur. An optimal route may be found by utilizing information obtained by CCTV using a control server.

In addition, the topology map-based route guiding apparatus 100 may find routes from a plurality of topology maps.

At step S540, the topology map-based route guiding apparatus 100 may determine whether there is a single destination when the user's current location has been estimated (YES at step S520) and when the destination has been determined (YES at step S530).

At step S550, when the origin and the destination are set and when there is not a single destination (NO at step S540), the topology map-based route guiding apparatus 100 may start the route finding to the destination.

When the inputted user's surrounding image is one and there are many locations extracted from the image on the map, various origin vertices may occur.

The topology map-based route guiding apparatus 100 may find multiple routes in a topology map while avoiding duplication.

At step S551, before finding the route from the origin vertex estimated as the current location to a destination vertex, the topology map-based route guiding apparatus 100 may list the vertices estimated as the current location in the order of longer distance to the destination.

The topology map-based route guiding apparatus 100 may find the routes by utilizing A* algorithm (typically called an A star algorithm) from the origin vertex estimated as the current location to the destination vertex.

Various factors may be input when the cost in A* algorithm is determined. The algorithm of the present disclosure may calculate the cost according to Equation 2, in consideration of a distance between the origin vertex and the destination vertex, the number of persons detected from CCTV, and an area of the passage estimated by CCTV.

$$cost ( edge id ) = distance ( vertex 1 , vertex 2 ) \times edge congestion degree \times manager factor \qquad [ Equation 2 ]$$

Here, vertex1 is the first side vertex of the edge determining the route, vertex 2 is the second side vertex of the edge, and distance (vertex1, vertex2) is the distance between the first side vertex and the second side vertex, and the edge congestion degree is the congestion degree for each edge, and manager factor is the route preference value of the manager for each edge.

One of the first side vertex or the second side vertex of the edge determining the route may be the origin, and the other one may be the destination. In other words, through Equation 2, the topology map-based route guiding apparatus 100 may determine the cost of each one among the plurality of candidate routes from the origin to the destination and may determine, as the final route, the candidate route having a lowest cost.

At step S552, the topology map-based route guiding apparatus 100 may determine whether the origin and the destination are in the same topology map.

At step S553, when the origin and the destination do not exist in the same topology map (NO at step S552), the topology map-based route guiding apparatus 100 may determine whether the topology maps where origin and destination exist may be combined. When the topology maps where the origin and the destination exist may be combined (YES at step S553), at step S554, the topology map-based route guiding apparatus 100 may combine them into one topology map including the origin and the destination.

For example, when the origin and the destination are in different layers or have different space names in the same layer, the topology map-based route guiding apparatus 100 may separately create the topology map.

For example, when names for steps or doors for elevator entry and exit are unified between topology maps, the topology map-based route guiding apparatus 100 may provide the same service though combining into one topology map.

When the user has input a plurality of destinations, the topology map-based route guiding apparatus 100 may generate the optimal route by utilizing a TSP algorithm.

After step S554 or when there is a single destination (YES at step S540), at step S555, the topology map-based route guiding apparatus 100 may determine whether the previous route has passed through the origin vertex estimated as the current location. When the previous route has passed through this origin vertex (YES at step S555), this means that the optimal route has already been found, and there is no need to find a new route.

In other words, only when the previous route has not passed through this origin vertex (NO at step S555), at step S556, a new route needs to be found to reduce the operation cost, and the topology map-based route guiding apparatus 100 may search a route in the topology map. The destination may also include a plurality of destination vertices, depending on its size.

The topology map-based route guiding apparatus 100 may calculate the congestion degree based on the number of persons in real time obtained through the CCTV of the user travel passage and the passage area. The congestion degree may be calculated for each edge.

The topology map-based route guiding apparatus 100 may detect the number of persons through the CCTV at step S10 and may calculate the congestion degree for each edge through Equation 1 at step S20.

$$edge conjestion degree = 1 + \frac{number of persons detected by CCTV}{optimal number of persons for passage} \qquad [ Equation 1 ]$$

Here, the optimal number of persons for passage is a number predetermined based on the passage area.

The preference is considered to be higher when the preference value preset by the manager is lower, and the preference may be set for each edge.

The topology map-based route guiding apparatus 100 may generate, as the final route, a route comprising the plurality of edges having the low congestion degree and the high preference.

At steps S556 and S557, the topology map-based route guiding apparatus 100 may determine, as the final route, the route of the shortest distance between the origin and the destination. Specifically, at step S557, the topology map-based route guiding apparatus 100 may determine whether the route of the shortest distance between the origin and the destination exists.

At steps S556 and S557, when the plurality of candidate routes having the same distance between the origin and the destination exists, the topology map-based route guiding apparatus 100 may determine, as the final route, the candidate route having the low congestion degree and the high preference among the plurality of candidate routes.

Therefore, when the route of the shortest distance between the origin and the destination exists (YES at step S557), at step S558, the topology map-based route guiding apparatus 100 may store the route. At step S559, the topology map-based route guiding apparatus 100 may find routes to all possible destination vertices and then may add the shortest route to the recommended routes. At step S560, the topology map-based route guiding apparatus 100 may add route information.

At step S50, the topology map-based route guiding apparatus 100 may visually notify all the recommended routes calculated after confirming all origin vertices included in the origin to the user through the guide map through the topology map.

When many destinations are input, the topology map-based route guiding apparatus 100 may generate the optimal route by utilizing a TSP algorithm at step S570 and may recommend the generated optimal routes to the user at step S580.

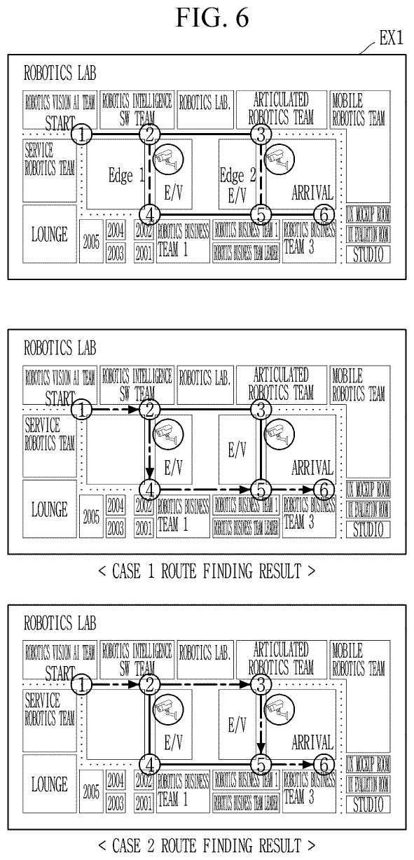

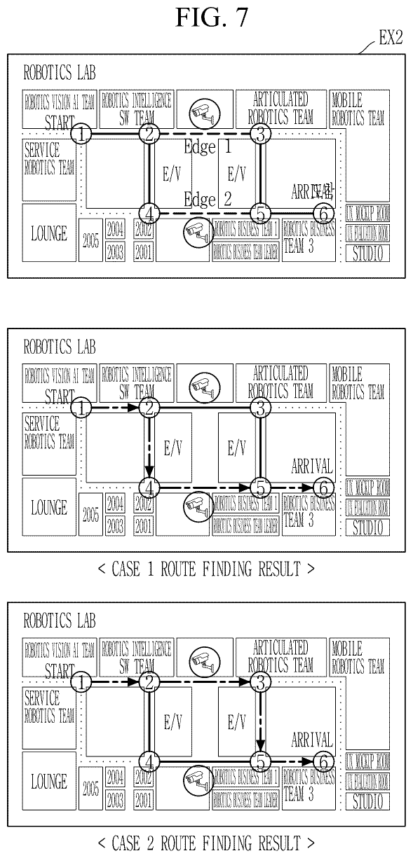

FIG. 6 and FIG. 7 are example diagram for explaining a topology map-based route guiding method according to an embodiment of the present disclosure.

FIG. 6 is an example diagram for explaining route guiding utilizing the congestion degree calculated by edge Equation 1.

$$edge conjestion degree = 1 + \frac{number of persons detected by CCTV}{optimal number of persons for passage} \qquad [ Equation 1 ]$$

Here, the optimal number of persons for passage is a number predetermined based on the passage area.)

As a premise of an example diagram EX1, Route 1 and Route 2 may be the same distance.

Route 1 may be a route passing through \textcircled{1}=\textcircled{2}−\textcircled{4}=\textcircled{5}=>\textcircled{6}, and Route 2 may be a route passing through \textcircled{1}=\textcircled{2}=\textcircled{3}=\textcircled{5}=\textcircled{6}.

The information of Edge 1 and Edge 2 detected through the CCTV will be as follows.
Edge 1: ((2)=>4): a distance 20, optimal number of persons: 5 persons
Edge 2: (3)=>5): distance 20, optimal number of persons: 5 persons

In Case 1, the number of persons detected by the CCTV of Passage 1 may be 1 person, and the number of persons detected by the CCTV of Passage 2 may be 5 persons. The topology map-based route guiding apparatus 100 may finally select Route 1 (reason: Edge 1 the congestion degree <Edge 2 the congestion degree).

$$cost ( edge id ) = distance ( vertex 1 , vertex 2 ) \times edge congestion degree \times manager factor \qquad [ Equation 2 ]$$

Here, vertex1 is the first side vertex of the edge determining the route, vertex 2 is the second side vertex of the edge, and distance (vertex1, vertex2) is the distance between the first side vertex and the second side vertex, and the edge congestion degree is the congestion degree for each edge, and manager factor is the route preference value of the manager for each edge.

The topology map-based route guiding apparatus 100 may recommend Route 1 to the user as the final route based on the cost calculated as below according to Equation 2.

$$\begin{matrix}Cost ( Edge 1 ) = distance ( Vertex 2 , Vertex 4 ) \times ( 1 + 1 / 5 ) \times 1 = 24 \\ Cost ( Edge 2 ) = distance ( Vertex 3 , Vertex 5 ) \times ( 1 + 5 / 5 ) \times 1 = 40\end{matrix}$$

In Case 2, the number of persons detected by the CCTV of Passage 1 may be 4 persons, and the number of persons detected by the CCTV of Passage 2 may be 2 persons. The topology map-based route guiding apparatus 100 may finally select Route 2 (reason: Edge 1 the congestion degree>Edge 2 the congestion degree).

In other words, the topology map-based route guiding apparatus 100 may recommend Route 2 to the user as the final route based on the cost calculated as below according to Equation 2.

$$\begin{matrix}Cost ( Edge 1 ) = distance ( Vertex 2 , Vertex 4 ) \times ( 1 + 4 / 5 ) \times 1 = 36 \\ Cost ( Edge 2 ) = distance ( Vertex 3 , Vertex 5 ) \times ( 1 + 2 / 5 ) \times 1 = 28\end{matrix}$$

FIG. 7 is an example diagram for explaining the route finding utilizing the manager factor (preference).

The manager factor may be the preference value predetermined by the manager.

In an example diagram EX2 of FIG. 7, the manager factor may be determined as min: 1.0, max: 2.0, default: 1.5.

In other words, the manager may designate a value closer to 1.0 for an edge through which more users are wished to pass, and the manager may designate a value closer to 2.0 for an edge through which less users are wished to pass. Accordingly, the manager may guide the service users to move along the intended route of the manager. For example, the manager may guide the road such that more persons may be gathered at a specific event space.

In the example diagram EX2, Route 1 and Route 2 may be assumed to be the same distance.
Route 1: \textcircled{1}=\textcircled{2}=\textcircled{4}=\textcircled{5}=\textcircled{6}
Route 2: \textcircled{1}=\textcircled{2}=\textcircled{3}=\textcircled{5}=\textcircled{6}

Edges 1 & 2 information may be supposed as follows.
Edge 1 (\textcircled{2}=>\textcircled{3}): distance 30, optimal number of persons: 15 persons, the number of detected persons 5 persons
Edge 2 (\textcircled{4}=>\textcircled{5}): distance 30, optimal number of persons: 15 persons, the number of detected persons 5 persons

Case 1 may indicate the case Route 1 passing through Edge 2 is wished to be passed through by persons.

By the manager, the manager factor of Edge 1 may be set as 2.0, and the manager factor of Edge 2 may be set as 1.0.

Accordingly, the topology map-based route guiding apparatus 100 may select Route 1 (reason: cost (Edge 1)<cost (Edge 2)).

In other words, the topology map-based route guiding apparatus 100 may recommend Route 1 to the user as the final route based on the cost calculated as below according to Equation 2.

$$\begin{matrix}Cost ( Edge 1 ) = distance ( Vertex 2 , Vertex 4 ) \times 5 / 15 \times 2. = 20 \\ Cost ( Edge 2 ) = distance ( Vertex 3 , Vertex 5 ) \times 5 / 15 \times 1. = 10\end{matrix}$$

Case 2 may indicate the case Route 2 passing through Edge 1 is wished to be passed through by persons.
Edge 1 the manager factor: 1.0
Edge 2 the manager factor: 2.0

The topology map-based route guiding apparatus 100 may select Route 2 as a recommended route (reason: cost (Edge 1)>cost (Edge 2)).

In other words, the topology map-based route guiding apparatus 100 may recommend Route 2 to the user as the final route based on the cost calculated as below according to Equation 2.

$$\begin{matrix}Cost ( Edge 1 ) = distance ( Vertex 2 , Vertex 4 ) \times 5 / 15 \times 1. = 10 \\ Cost ( Edge 2 ) = distance ( Vertex 3 , Vertex 5 ) \times 5 / 15 \times 2. = 20\end{matrix}$$

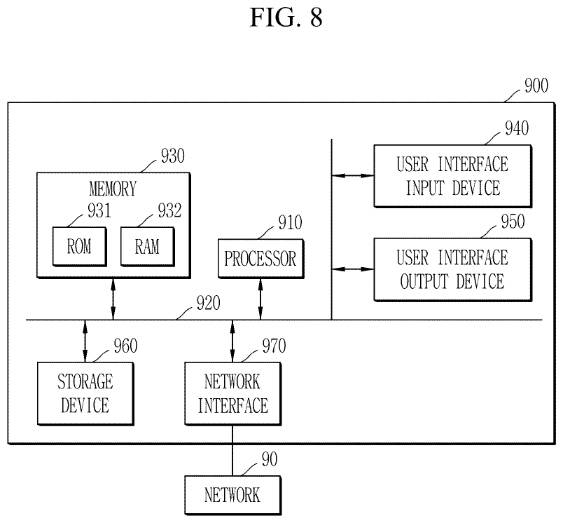

FIG. 8 is drawing for explaining a computing device according to an embodiment of the present disclosure.

Referring to FIG. 8, a topology map-based route guiding apparatus and method according to an embodiment may be implemented by using a computing device 900.

The computing device 900 may include at least one of a processor 910, a memory 930, the user interface input device 940, the user interface output device 950, and a storage device 960 that communicate through a bus 920. The computing device 900 may also include a network interface 970 electrically connected to a network 90. The network interface 970 may transmit or receive signals with other entities through the network 90.

The processor 910 may be implemented in various types, such as a micro controller unit (MCU), an application processor (AP), a central processing unit (CPU), a graphic processing unit (GPU), a neural processing unit (NPU), and the like. The processor 910 may be any type of semiconductor device capable of executing instructions stored in the memory 930 or the storage device 960. The processor 910 may be configured to implement the functions and methods described above with respect to FIG. 1-FIG. 7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of a topology map-based route guiding apparatus and a topology map-based route guiding method according to an embodiment may be implemented as a program or software executable by the computing device 900, and program or software may be stored in a computer-readable medium.

In some embodiments, at least some configurations or functions of a topology map-based route guiding apparatus and a topology map-based route guiding method according to an embodiment may be implemented by using hardware or circuitry of the computing device 900 or may also be implemented as separate hardware or circuitry that may be electrically connected to the computing device 900.

While the present disclosure has been described in connection with the embodiments, it should be understood that the present disclosure is not limited to the disclosed embodiments. On the contrary, the present disclosure is intended to cover various modifications and equivalent arrangements included within the spirit and scope of the appended claims.

### DESCRIPTION OF SYMBOLS

10: guide map image
100: topology map-based route guiding apparatus
110: topology map
120: destination determiner
130: origin determiner
140: route generator

What is claimed is:

1. A topology map-based route guiding apparatus, comprising:
a topology map generated from a guide map image based on an optical character recognition (OCR) character recognition and an image processing;
a destination determiner configured to determine, as a destination, a location selected by a user in the topology map;
an origin determiner configured to determine, as an origin, a current location of the user detected by comparing a character recognized from a surrounding image provided by the user and location information of the topology map; and
a route generator configured to generate a final route from the origin to the destination based on a congestion degree and a preference.

2. The topology map-based route guiding apparatus of claim 1, wherein the topology map comprises:
a plurality of vertices disposed in a travel passage on the map and respectively storing the location information; and
edges connecting the vertices.

3. The topology map-based route guiding apparatus of claim 2, wherein the origin determiner is configured to estimate, as the current location of the user, a specific vertex on the topology map having location information matching the recognized character in the surrounding image.

4. The topology map-based route guiding apparatus of claim 3, wherein the route generator is configured to, when a route passing through the origin and the destination is detected from among pre-stored routes, use a detected route as the final route and stop route generation.

5. The topology map-based route guiding apparatus of claim 3, wherein:
the route generator is configured to calculate the congestion degree based on the number of persons in real time obtained through a closed-circuit television (CCTV) of the travel passage and a passage area, and
the congestion degree is calculated for each edge.

6. The topology map-based route guiding apparatus of claim 5, wherein the route generator is configured to calculate the congestion degree for each edge through Equation 1,
$$edge conjestion degree = 1 + \frac{number of persons detected by CCTV}{optimal number of persons for passage} \qquad [ Equation 1 ]$$
wherein an optimal number of persons for passage is a number predetermined based on passage area.

7. The topology map-based route guiding apparatus of claim 6, wherein the preference is considered to be higher when a preference value preset by a manager is lower, and the preference is set for each edge.

8. The topology map-based route guiding apparatus of claim 7, wherein the route generator is configured to generate, as the final route, a route comprising a plurality of edges having a low congestion degree is low and a high preference.

9. The topology map-based route guiding apparatus of claim 1, wherein the route generator is configured to determine, as the final route, a route of a shortest distance between the origin and the destination,
wherein, when a plurality of candidate routes having the same distance between the origin and the destination exists, the candidate route having a low congestion degree is low and a high preference among the plurality of candidate routes is determined as the final route.

10. The topology map-based route guiding apparatus of claim 9, wherein the route generator is configured to determine cost for each candidate route through Equation 2 and determine a candidate route having a lowest cost as the final route,
$$cost ( edge id ) = distance ( vertex 1 , vertex 2 ) \times edge congestion degree \times manager factor \qquad [ Equation 2 ]$$
wherein vertex1 is a first side vertex of the edge determining the route, vertex 2 is a second side vertex of the edge, distance (vertex1, vertex2) is a distance between the first side vertex and the second side vertex, an edge congestion degree is the congestion degree for each edge, and a manager factor is a route preference value of a manager for each edge.

11. A topology map-based route guiding method, comprising:
providing a topology map generated from a guide map image based on an OCR character recognition and an image processing;
determining, as a destination, a location selected by a user in the topology map;
determining, as an origin, a current location of the user detected by comparing a character recognized from a surrounding image provided by the user and location information of the topology map; and
generating a final route from the origin to the destination based on a congestion degree and a preference.

12. The topology map-based route guiding method of claim 11, wherein the topology map comprises:
a plurality of vertices disposed in a travel passage on the map and respectively storing the location information; and
edges connecting the vertices.

13. The topology map-based route guiding method of claim 12, wherein determining the origin comprises estimating, as the current location of the user, a specific vertex on the topology map having location information matching the recognized character in the surrounding image.

14. The topology map-based route guiding method of claim 13, wherein generating the final route comprises, when a route passing through the origin and the destination is detected from among pre-stored routes, using a detected route as the final route and stopping stop route generation.

15. The topology map-based route guiding method of claim 13, wherein:
generating the final route comprises:
calculating the congestion degree based on the number of persons in real time obtained through a CCTV of the travel passage and a passage area; and
calculating the congestion degree for each edge.

16. The topology map-based route guiding method of claim 15, wherein generating the final route further comprises calculating the congestion degree for each edge through Equation 1,
$$edge conjestion degree = 1 + \frac{number of persons detected by CCTV}{optimal number of persons for passage} \qquad [ Equation 1 ]$$
wherein, an optimal number of persons for passage is a number predetermined based on passage area.

17. The topology map-based route guiding method of claim 16, wherein the preference is considered to be higher when a preference value preset by a manager is lower, and the preference is set for each edge.

18. The topology map-based route guiding method of claim 17, wherein generating the final route further comprises generating, as the final route, a route comprising a plurality of edges having a low congestion degree and a high preference.

19. The topology map-based route guiding method of claim 11, wherein generating the final route comprises determining, as the final route, a route of a shortest distance between the origin and the destination is shortest,
wherein, when a plurality of candidate routes having the same distance between the origin and the destination exists, the candidate route having a low congestion degree and a high preference among the plurality of candidate routes is determined as the final route.

20. The topology map-based route guiding method of claim 19, wherein generating the final route further comprises determining a cost for each candidate route through Equation 2 and determining a candidate route having a lowest cost as the final route,
$$cost ( edge id ) = distance ( vertex 1 , vertex 2 ) \times edge congestion degree \times manager factor \qquad [ Equation 2 ]$$
wherein, vertex1 is a first side vertex of the edge determining the route, vertex 2 is a second side vertex of the edge, distance (vertex1, vertex2) is a distance between the first side vertex and the second side vertex, an edge congestion degree is the congestion degree for each edge, and a manager factor is a route preference value of a manager for each edge.
